(19) United States
(12) Patent Application Publication
(10) Pub. No.: US 2016/0013474 A1
(43) Pub. Date: Jan. 14, 2016

(54) Porous Lithium Mangaense Phosphate-Carbon Composite Material, Preparation Method and Application Thereof

(71) Applicant: SUZHOU INSTITUTE OF NANO-TECH AND NANO-BIONICS OF CHINESE ACADEMY OF SCIENCES, SIP Suzhou (CN)

(72) Inventors: Tao Liu, SIP Suzhou (CN); Xiaodong Wu, SIP Suzhou (CN)

(21) Appl. No.: 14/770,727

(22) PCT Filed: Mar. 4, 2014
(86) PCT No.: PCT/CN2014/000196

§ 371 Date: Aug. 26, 2015

(30) Foreign Application Priority Data
Mar. 4, 2013 (CN) 201310067317.2
Jun. 19, 2013 (CN) 201310242754.3

(51) Int. Cl. H01M 4/36; H01M 4/587; H01M 10/0525; H01M 4/58

(52) U.S. Cl. CPC H01M 4/364; H01M 4/5825; H01M 4/587; H01M 10/0525; H01M 2004/028

(57) ABSTRACT

A porous lithium manganese phosphate-carbon composite material, and a preparation and application thereof. Multiple nano-pores are distributed in the composite material, and the composite material includes a lithium manganese phosphate material and carbon. The method for preparing the porous lithium manganese phosphate-carbon composite material includes the steps of: mixing a porous pyrophosphate material with a doped metal source, a lithium source, phosphate and a carbon source and then drying them to obtain a reaction precursor, and calcining the reaction precursor at a constant temperature under a protective atmosphere to obtain the composite material. The lithium manganese phosphate material contains compounds in a general formula of LiMnₓM₁₋ₓPO₄, and the porous pyrophosphate material contains compounds in a general formula of (MnₓM₁₋ₓ)₂P₂O₇ and 0 wt % to 50 wt % of carbon, where M comprises a transition metal, and 0.6≦x≦1.

### TECHNICAL FIELD OF THE PRESENT INVENTION

The present invention particularly relates to a lithium manganese phosphate-carbon composite material having a porous nanostructure, a preparation method and an application thereof, for example, an application in batteries, particularly in cathodes of Li-ion secondary batteries.

### BACKGROUND OF THE PRESENT INVENTION

The phosphate material LiMPO₄ (M=Fe, Mn, Ni, Co) of an olivine structure, serving as the cathode material of a Li-ion battery, has a theoretical capacity of about 170 mAh/g, and meanwhile has many advantages such as stable structure, low reactivity with the electrolyte, high safety and good battery cyclability. Among such phosphate materials, LiFePO₄ is relatively simple in synthesis and has realized mass production and marketing. However, due to a low lithium deintercalation potential plateau (about 3.4 V), LiFePO₄ reduces the overall energy density of a battery, so that the application of LiFePO₄ in electric vehicles is restricted. As LiMnPO₄ has a working voltage of 4.1 V vs. Li, LiMnPO₄ is able to increase the energy density by about 20% on the basis of that of LiFePO₄. Therefore, LiMnPO₄ may become a first choice of cathode material of batteries for electric vehicles in the future.

The main restriction to the large-scale application of LiMnPO₄ is a lower electron conductivity (<10⁻¹⁰ s·cm⁻¹) and Li-ion diffusion rate than LiFePO₄, thereby resulting in an extremely low charge/discharge capacity and low rate performance of batteries. In order to improve the Li-ion transmission efficiency and electron conduction efficiency, the size of lithium manganese phosphate particles must be reduced to a nanometer level. However, it is difficult to obtain LiMnPO₄ nanostructure material by the traditional solid-state reaction methods. In addition, it is also required to perform iron doping and effective carbon coating to lithium manganese phosphate so as to improve the electrical conductivity of the material. Although it has been reported that the nanometer-level lithium manganese phosphate material has been obtained by a hydrothermal method , a sol-gel method or other methods, such preparation methods are complicated and high in cost; furthermore, the dispersed nanoparticles have a very low tap density, so that the volumetric energy density is very low and it is disadvantageous for practical applications. In addition, as LiMnPO₄ does not show good affinity with carbon, the effect of carbon coating in the existing preparation methods is generally not ideal. In order to obtain a higher discharge capacity, it is required to add as high as 20 wt % to 30 wt % carbon, which, however, further reduces the power density of the batteries.

### SUMMARY OF THE PRESENT INVENTION

An objective of the present invention is to, in view of the deficiencies in the prior art, provide a lithium manganese phosphate-carbon composite material having a porous structure and a preparation method thereof.

To achieve above objective, the present invention employs the following technical solutions.

A porous lithium manganese phosphate-carbon composite material is provided, wherein multiple nano-pores are distributed in the composite material, the composite material includes lithium manganese phosphate material and carbon, and the lithium manganese phosphate material contains compounds in a general formula of LiMnₓM₁₋ₓPO₄, where M includes any one or more than two of Fe, Co, Ni, Mg, Cu, Zn, Zr, Ti, Al, Cr and Ge, 0.6≦x≦1, and the mass percentage content of carbon in the composite material is 0.1% to 30%.

Preferably, 0.7≦x≦0.8.

Preferably, M includes Fe, Co, Mg and Ni.

Further, the composite material preferably contains 1 wt % to 15 wt % of carbon.

More preferably, the composite material contains 3 wt % to 5 wt % of carbon.

Multiple pores having a pore diameter of 1 nm to 500 nm are distributed in the composite material. Preferably, multiple pores having a pore diameter of 1 nm to 100 nm are distributed in the composite material. More preferably, multiple pores having a pore diameter of 3 nm to 50 nm are distributed in the composite material.

The material thickness between adjacent pores in the composite material is 1 nm to 500 nm. Preferably, the material thickness between adjacent pores in the composite material is 1 nm to 200 nm. More preferably, the material thickness between adjacent pores in the composite material is 20 nm to 70 nm.

The volume of each of the pores distributed in the composite material is 0.01 cm³/g to 500 cm³/g. Preferably, the volume of each of the pores distributed in the composite material is 0.05 cm³/g to 1.0 cm³/g. More preferably, the volume of each of the pores distributed in the composite material is 0.05 cm³/g to 0.2 cm³/g.

The composite material refers to particles having a particle size of 0.1 μm to 500 μm. Preferably, the composite material refers to particles having a particle size of 0.1 μm to 150 μm. More preferably, the composite material refers to particles having a particle size of 1 μm to 50 μm.

A specific surface area of the composite material is 9 m²/g to 200 m²/g. Preferably, a specific surface area of the composite material is 9 m²/g to 100 m²/g. More preferably, a specific surface area of the composite material is 15 m²/g to 30 m²/g.

A tap density of the composite material is 0.1 g/cm³ to 10.0 g/cm³. Preferably, a tap density of the composite material is 0.5 g/cm³ to 4.0 g/cm³. More preferably, a tap density of the composite material is 0.8 g/cm³ to 2.0 g/cm³.

The above characteristics of the material obtained by the present invention greatly improve the electrical properties and volumetric energy density of the material, because, first, the size of primary particles forming the porous structure is below 100 nm, so that the transmission distance of Li ions and electrons in the active substance is shortened, and the rate performance is thus improved; second, the porous structure facilitates the permeation of an electrolyte; third, the porous structure may further slowly release the volumetric expansion of the material during the charge/discharge process and thus improve the structural stability and cyclic stability; and fourth, the porous microparticles have a higher tap density than the monodispersed nanoparticles (less than 0.5 g/cm³) and thus a higher volumetric energy density.

Further, the carbon is at least from amorphous carbon and/or carbon nanotubes and/or carbon nanofibers contained in the composite material.

Further, the carbon nanotubes include single-walled carbon nanotubes and multi-walled carbon nanotubes.

Further, the composite material contains carbon nanotubes or carbon nanofibers. Compounds in a general formula of LiMnₓM₁₋ₓPO₄ added during the preparation of the precursor is in-situ formed on a surface of the carbon nanotubes or carbon nanofibers. It can be seen from an electronic microscopic photo that the carbon nanofibers are distributed on the surface of and inside the lithium manganese phosphate particles, and the distance from the carbon nanofibers to the lithium manganese phosphate particles is less than 1 nm, so that the carbon nanotubes are in closer contact with the active substance. In comparison to the simple mixing of the compounds with the carbon nanotubes or nanofibers, the in-situ compounding of the carbon nanotubes and the compounds in a general formula of LiMnₓM₁₋ₓPO₄, results in the characteristics of a closer contact of lithium manganese phosphate with carbon nanotubes and a faster transmission of Li-ions and electrons to the inside of the active substance through the carbon nanotubes or nanofibers during the charge/discharge process.

Further, a distance from the carbon nanotubes or carbon nanofibers to the surface of the compounds in a general formula of LiMnₓM₁₋ₓPO₄ is less than 1 nm.

Further, the surface layer of the composite material is further coated with amorphous carbon.

A method for preparing the porous lithium manganese phosphate-carbon composite material is provided, including the following steps of:
mixing a pyrophosphate material with a lithium source to obtain a reaction precursor, and then calcining the reaction precursor at a constant temperature under a protective atmosphere or an air atmosphere to obtain the porous lithium manganese phosphate-carbon composite material; and
the pyrophosphate material contains compounds in a general formula of (MnₓM₁₋ₓ)₂P₂O₇ and 0 wt % to 30 wt % of carbon, where M is one or more than two of metals; M may be any one or more than two selected from, but not limited to, Fe, Co, Ni, Mg, Cu, Zn, Zr, Ti, Al, Cr and Ge, and 0.6≦x≦1, preferably, 0.7≦x≦0.8.

Further, M may be selected from Fe, Co, Mg and Ni.

Further, the method for preparing a porous lithium manganese phosphate-carbon composite material includes the following steps of: mixing the pyrophosphate material with the lithium source, or adding one or more than two of a doped metal source, a phosphorous source and a carbon source and then mixing, to obtain the reaction precursor, and then calcining the reaction precursor at a constant temperature under a protective atmosphere or an air atmosphere for a certain period of time to obtain the porous lithium manganese phosphate-carbon composite material.

In the method for preparing a porous lithium manganese phosphate-carbon composite material, the constant-temperature calcining of the reaction precursor is carried out at a temperature from 100° C. to 2000° C., and the constant-temperature calcining of the reaction precursor lasts for 0-72 h.

Further, in the method for preparing a porous lithium manganese phosphate-carbon composite material, the constant-temperature calcining of the reaction precursor is carried out at a temperature from 500° C. to 900° C., and the constant-temperature calcining of the reaction precursor lasts for 1-30 h.

Further, the method for preparing a porous lithium manganese phosphate-carbon composite material includes the following steps of: mixing the porous pyrophosphate material with a doped metal source, a lithium source, phosphate and a carbon source and then drying them to obtain a reaction precursor, and calcining the reaction precursor at a constant temperature of 500° C. to 900° C. under a protective atmosphere for 1-30 h to obtain the porous lithium manganese phosphate-carbon composite material.

Further, the method for preparing a porous lithium manganese phosphate-carbon composite material includes the following step of: mixing a manganese source with a phosphorous source, or adding one or more than two of a doped metal source and a carbon source and then mixing, to obtain the pyrophosphate material.

Further, in the method for preparing a porous lithium manganese phosphate-carbon composite material, a temperature for heat treatment to the pyrophosphate ranges from 100° C. to 2000° C., and the heat treatment lasts for 0-72 h .

Further, in the method for preparing a porous lithium manganese phosphate-carbon composite material, a temperature for heat treatment to the pyrophosphate ranges from 400° C. to 800° C., and the heat treatment lasts for 2-15 h .

In the method for preparing a porous lithium manganese phosphate-carbon composite material, the pyrophosphate material is a porous material. Further, the pore diameter of the pyrophosphate material is 1 nm to 500 nm, and the particle size is 0.1 μm to 500 μm. Preferably, the pore diameter is 1 nm to 100 nm, and the particle size is 0.1 μm to 150 μm. More preferably, the pore diameter is 3 nm to 50 nm, and the particle size is 1 μm to 50 μm.

In the method for preparing a porous lithium manganese phosphate-carbon composite material, the reaction solution for preparing pyrophosphate may be stirred at 10° C. to 100° C. for 0.5-48 h, filtered, dried, and heat-treated under a protective atmosphere or an air atmosphere for a certain period of time.

In the method for preparing a porous lithium manganese phosphate-carbon composite material, the raw materials for preparing pyrophosphate may be mixed for 4-20 h, and then heat-treated under a protective atmosphere or an air atmosphere for a certain period of time.

In the method for preparing a porous lithium manganese phosphate-carbon composite material, the mixing method may be selected from, but not limited to, ball-milling, stirring and grinding. The mixing method is preferably ball-milling.

In the method for preparing a porous lithium manganese phosphate-carbon composite material, the solvent for ball-milling may be selected from, but not limited to, water, methanol, ethanol, acetone, ethyl acetate, benzene, methylbenzene, dichloroethane, trichloroethylene, etc. The solvent is preferably ethanol.

In the method for preparing a porous lithium manganese phosphate-carbon composite material, a process for preparing the pyrophosphate material includes the following steps of:
dispersing a manganese source and a phosphorus source, added with carbon nanotubes/nanofibers, or further added with a doped metal source, in a solvent consisting of ethanol and water, and then performing heat treatment under a protective atmosphere or an air atmosphere to form a manganese pyrophosphate-carbon nanotubes/nanofibers composite, i.e., the pyrophosphate material.

Furthermore, in the method for preparing a porous lithium manganese phosphate-carbon composite material, the process for preparing the pyrophosphate material includes the following steps of: mixing manganese nitrate aqueous solution with phosphoric acid aqueous solution, using a mixture of ethanol and water as a solvent, adding and dispersing carbon nanotubes/nanofibers in the solution, stirring the reaction solution for 0.5-48 h at 10-100° C., filtering and drying, and performing heat treatment at 400-800° C. under an inert atmosphere to obtain the manganese pyrophosphate-carbon nanotube/nanofibers composite.

Furthermore, the method for preparing a porous lithium manganese phosphate-carbon composite material includes the following steps of: mixing a manganese salt with phosphoric acid in a solvent mainly consisting of ethanol and water, stirring for 1-48 h at 10-100° C., separating and drying the solid, and performing heat treatment to the solid at a temperature of 400-800° C. under an air atmosphere or a protective atmosphere to obtain the pyrophosphate material.

The pyrophosphate is a metal pyrophosphate or a composite of a metal pyrophosphate and carbon.

Further, the metal pyrophosphate is manganese pyrophosphate (Mn₂P₂O₇), iron manganese pyrophosphate ((MnₓFe₁₋ₓ)₂P₂O₇), cobalt manganese pyrophosphate ((MnₓCo₁₋ₓ)₂P₂O₇), magnesium manganese pyrophosphate ((MnₓMg₁₋ₓ)₂P₂O₇), nickel manganese pyrophosphate ((MnₓNi₁₋ₓ)₂P₂O₇), magnesium iron manganese pyrophosphate ((MnₓFe_{y}Mg_{1-x-y})₂P₂O₇), cobalt iron manganese pyrophosphate ((MnₓFe_{y}Co_{1-x-y})₂P₂O₇), nickel iron manganese pyrophosphate ((MnₓFe_{y}Ni_{1-x-y})₂P₂O₇), etc., where 0.6≦x<1, preferably, 0.7≦x<0.8.

Further, the composite of the metal pyrophosphate is a manganese pyrophosphate (Mn₂P₂O₇)-carbon nanotube composite material, an iron manganese pyrophosphate ((MnₓFe₁₋ₓ)₂P₂O₇)-carbon nanotube composite material, manganese pyrophosphate (Mn₂P₂O₇)-carbon, iron manganese pyrophosphate ((MnₓFe₁₋ₓ)₂P₂O₇)-carbon, cobalt manganese pyrophosphate ((MnₓCo₁₋ₓ)₂P₂O₇)-carbon, etc., where 0.6≦x≦1, preferably, 0.7≦x≦0.8.

As a feasible implementation solution, the process for preparing the porous pyrophosphate material includes the following steps of:

s1: adding carbon nanotubes/nanofibers in the reaction solution for preparing manganese phosphate to obtain a manganese phosphate-carbon nanotube/nanofibers composite; and

s2: performing heat treatment to the manganese phosphate-carbon nanotube/nanofibers composite under a protective atmosphere to form a porous manganese pyrophosphate-carbon nanotube/nanofibers composite, i.e., the porous pyrophosphate material.

More specifically, the process for preparing the porous pyrophosphate material includes the following steps of: mixing manganese nitrate aqueous solution with phosphoric acid aqueous solution, using a mixture of ethanol and water as a solvent, adding and dispersing carbon nanotubes/nanofibers in the solution, stirring the reaction solution for 0.5-48 h at 10-100° C., filtering and drying, and performing heat treatment at 400-800° C. under an inert atmosphere to obtain the porous manganese pyrophosphate-carbon nanotube/nanofibers composite.

Further, the preparation method includes the following steps of: mixing a manganese salt, phosphate, a doped metal source and a carbon source, and then performing heat treatment at 400-800° C. under an inert or air atmosphere to obtain the porous pyrophosphate material.

In an optional implementation solution, the preparation method may further include the following steps of: mixing a manganese salt with phosphoric acid in a solvent mainly consisting of ethanol and water, stirring for above 1 h at 10-100° C., and separating and drying the solid. In the preparation method, the formation of micron-level granular solid of a micron size through the tight agglomeration of sediment products is necessary for the acquisition of porous micron-level Mn₂P₂O₇ particles and the final porous lithium manganese phosphate material in subsequent steps, so no any surfactant is required. Then, the solid is heat-treated at 400-800° C. under an air atmosphere or a protective atmosphere to obtain porous micron-level Mn₂P₂O₇ particles, i.e., the porous pyrophosphate material.

In the present invention, the composition and structure of a cathode active material and a lithium battery are analyzed by the following methods.

X-rays diffraction: when the crystalline substance is irradiated by X-rays of a certain wavelength, the X-rays are scattered when encountering regularly arranged atoms or ions in the crystal, and the phase of the scattered X-rays in a certain direction is enhanced, so that a specific diffraction phenomenon corresponding to the crystal structure is shown. This test may be carried out on an XRD diffractometer, for example, a Bruker D8 Advance X-rays diffractometer.

Analysis of specific surface area: a sample is placed in a nitrogen atmosphere, and the surface (surface of through holes outside and inside particles) will show physical adsorption at a low temperature. When the adsorbed gas reaches a balance, an equilibrium adsorption pressure and an amount of the adsorbed gas are measured, and the adsorption capacity of a monomolecular layer of the sample to be tested may be obtained according to a BET equation, so that the specific surface area of the sample is calculated. This test may be carried out on a porous analyzer, for example, Micromeritics ASAP 2020.

Analysis of metal compositions: the composition and content of elements in the substance are determined by the wavelength and intensity of a characteristic spectrum emitted by gaseous atoms or ions of metal elements after excited. This test may be carried out on an atomic emission spectrometer, for example, Varian_{—}700-ES.

Analysis of particle size: statistical analysis is performed through SEM and TEM pictures.

Pore volume: the pore volume is derived according to the theoretical solid-state density of a material and a measured tap density.

Constant-current charge/discharge test: a coin cell is assembled, and a charge/discharge test is performed at a constant current within a set range of voltage. This test may be carried out on a cycle tester, for example, Neware BTS2300.

The manganese source is substance for providing manganese, and may be selected from, but not limited to, a water-insoluble manganese source compound, for example, trimanganese tetroxide, manganese sesquioxide, manganese carbonate, manganese dioxide or manganese hydroxide, or a water-soluble manganese source compound, for example, manganese acetate, manganese acetate tetrahydrate, manganese chloride, manganese chloride tetrahydrate, manganese tetrachloride, manganese sulfate, manganese sulfate monohydrate, manganese sulfate dihydrate, manganese sulfate trihydrate, manganese sulfate tetrahydrate, manganese sulfate pentahydrate, manganese sulfate hexahydrate, manganese sulfate heptahydrate or manganese nitrate.

Further, the manganese source may be selected from, but not limited to, manganese nitrate, manganese acetate, manganese sulfate and hydrates thereof.

Further, the anion in the doped metal source is not specifically limited, and, for example, the doped metal source may be sulfate, nitrate, hydrochloride, acetate, oxalate, phosphate, etc. Form the standpoint of avoiding residual impurities in the obtained anode active material, organic acid salts, for example, acetate and sulfate, are preferably used. For example, the doped metal source may be selected from, but not limited to, one or a combination of more of soluble metal compounds of Fe, Co, Ni, Mg, Cu, Zn, Zr, Ti, Al, Cr, Ni, Ge, etc. Further, the doped metal source may be selected from, but not limited to, ferric phosphate, ferrous oxalate, magnesium oxalate, magnesium acetate, ferrous sulfate, cobalt acetate, copper sulfate, nickel acetate, nickel sulfate, magnesium acetate, zinc acetate or ferric nitrate. Furthermore, the doped metal source may be selected from ferric phosphate, ferrous oxalate, magnesium oxalate, ferrous sulfate, ferric phosphate, cobalt sulfate, nickel sulfate, ferric nitrate and hydrates thereof. Furthermore, the doped metal source may be selected from ferric phosphate, ferrous oxalate, ferric nitrate, ferrous sulfate, nickel sulfate and magnesium oxalate.

Further, the phosphorus source is substance for providing phosphorus, and may be selected from, but not limited to, phosphoric acid (H₃PO₄), ammonium phosphate ((NH₄)₃PO₄), diammonium hydrogen phosphate ((NH₄)₂HPO₄), ammonium dihydrogen phosphate (NH4H₂PO₄), phosphorus pentoxide (P₂O₅), sodium dihydrogen phosphate, potassium dihydrogen phosphate, disodium hydrogen phosphate or dipotassium hydrogen phosphate. Furthermore, the phosphorus source may be selected from phosphoric acid (H₃PO₄), diammonium hydrogen phosphate ((NH₄)₂HPO₄) and ammonium dihydrogen phosphate (NH4H₂PO₄).

Further, the lithium source is substance for providing lithium, and may be selected from, but not limited to, lithium hydroxide (LiOH), lithium carbonate (Li₂CO₃), lithium chloride (LiCl), lithium acetate (CH₃COOLi), lithium sulfate, lithium nitrate, lithium iodide, lithium t-butoxide, lithium benzoate, lithium formate, lithium fluoride, lithium chromate, lithium citrate tetrahydrate, lithium aluminum tetrachloride, lithium bromide, lithium tetrafluoroborate, lithium phosphate, dilithium hydrogen phosphate, lithium dihydrogen phosphate or lithium oxalate. Furthermore, the lithium source may be selected from lithium hydroxide (LiOH), lithium carbonate (Li₂CO₃), lithium chloride (LiCl) or lithium acetate (CH₃COOLi).

Further, the carbon source includes carbon particles and/or a carbon precursor converted to conductive carbon by calcining.

The known carbon particles may be used as carbon particles of interest and the carbon particles are not limited thereto. The carbon particles may be, for example, carbon black, acetylene black, fullerene, carbon nanotubes (multi-walled carbon nanotubes, single-walled carbon nanotubes), carbon nanofibers, etc.

The carbon precursor may be, for example natural and synthetic organic polymer compounds (particularly water-soluble substance), such as polyethylene glycol, polyvinyl alcohol, polyolefin, polyacrylonitrile, cellulose, starch, granulated sugar, glucose, sucrose, maltose.; and polymerizable monomers (particularly unsaturated organic compounds containing carbon-carbon double bonds), such as acrylonitrile, divinyl benzene, vinyl acetate. Other suitable carbon precursors may be, for example, sugars, such as glucose; natural and synthetic organic polymers, such as cellulose acetate; aromatic compounds, such as aromatic acids (e.g., pyromellitic acid); organic solvents, such as dialkyl ketone (e.g., acetone) and alcohols (e.g., ethanol); and, citric acid, asphalt, Vitamin C, etc. Furthermore, the carbon precursor may be selected from polyethylene glycol, polyvinyl alcohol and glucose.

Further, the protective atmosphere is a closed gas environment having anti-corrosion components for preventing any component in a particular reaction system from reacting with foreign matters or preventing foreign matters from being introduced into a particular reaction system, and may be selected from, but not limited to, an atmosphere formed of any one or a combination of more than two of nitrogen, argon, a mixed gas of argon and hydrogen, a mixed gas of nitrogen and hydrogen, and acetylene. Furthermore, the protective atmosphere may be nitrogen, argon and a combination thereof.

An electrode is provided, including a substrate and a coating material distributed on the surface of the substrate, wherein the coating material contains the porous lithium manganese phosphate-carbon composite material described above.

Further, the coating material further includes a conductive material and/or a binder.

The binder may be selected from, but not limited to, polytetrafluoroethylene, polyvinylidene fluoride, etc., and the conductive agent may be selected from, but not limited to, acetylene black, carbon black, graphite, etc.

To facilitate the application of the coating material onto the surface of the substrate, the porous lithium manganese phosphate-carbon composite material, the conductive material and the binder may be dispersed in a solvent to form slurry, and then the slurry is coated on the substrate by a scraper, where the solvent may be, but not limited to, N-methylpyrrolidone, etc.

A battery is provided, including the lithium manganese phosphate-carbon composite material or the electrode described above.

As a typical implementation solution, the battery includes an anode, a cathode, a diaphragm and an electrolyte, the cathode being the electrode described above.

Further, the battery includes a primary or secondary Li-ion battery.

The material of the anodes includes, for example, carbon material, such as artificial graphite, natural graphite, graphitized carbon fibers or amorphous carbon; lithium; alloys of lithium with silicon (Si), aluminum, tin (Sn), lead (Pb), zinc, bismuth (Bi), indium (In), magnesium, gallium (Ga) or cadmium (Cd); metal compounds which may be alloyed, such as Sn alloy and Al alloy; and, composites including metal compounds and carbon materials. Examples of a anode current collector include: copper, stainless steel, aluminum, nickel, titanium, sintered carbon, copper or stainless steel which is surface-treated by using carbon, nickel, titanium or silver, and aluminum cadmium alloy. The anode current collector may be used in any form of a membrane, a slice, a foil, a net, a porous structure, foam and non-woven fabric. The anode current collector is manufactured by scraping, metal calendering or other processes well-known in the art.

The electrolyte may be a liquid electrolyte, and may also be a solid electrolyte, an electrolyte gel containing a solvent, etc. Solution obtained by dissolving the electrolyte in an aprotic and non-aqueous solvent may be used as the liquid electrolyte. The non-aqueous solvent may be, for example, cyclic carbonate, such as ethylene carbonate, propylene carbonate, butylene carbonate, vinylene carbonate, etc.; chain carbonate, such as dimethyl carbonate, diethyl carbonate and dipropyl carbonate; and, γ-butyrolactone, sulfolane, 1,2-dimethoxyethane, 1,2-diethoxyethane, 2-methyltetrahydrofuran, 3-methyl-1,3-dioxolame, methyl propionate, methyl butyrate, etc. Particularly, from the standpoint of voltage stability, the non-aqueous solvent is preferably cyclic carbonate, such as ethylene carbonate, propylene carbonate and vinylene carbonate, and chain carbonate, such as dimethyl carbonate, diethyl carbonate and dipropyl carbonate. The non-aqueous solvent may be used alone, or a mixture of two or more thereof may be used. Lithium salts such as LiPF₆, LiClO₄, LiAsF₆, LiBF₄, LiCF₃SO₃ and LiN(CF₃SO₂)₂ may be used as the electrolyte. Among the lithium salts, LiPF₆ and LiBF₄ are preferable. The solid electrolyte may be, for example, a solid inorganic electrolyte, such as lithium nitride and lithium iodide, and an organic polymer electrolyte, such as poly(ethylene oxide), poly(methacrylate) and poly(acrylate). In addition, the material for forming the electrolyte gel is not specifically limited as long as this material may be gelled to absorb the liquid electrolyte. Here, examples of this material are fluorine polymers, such as poly(vinylidene fluoride) and vinylidene fluoride/hexafluoropropylene polymer.

The structure of the battery provided by the present invention is not specifically limited to a cylindrical, square, coin or button shape, and may be of various sizes, for example, thin, large size, etc. In addition, the present invention may be applied to primary or secondary batteries.

Compared with the prior art, the present invention has at least the following advantages:

(1) the lithium manganese phosphate-carbon composite material is a micron-level lithium manganese phosphate material having nano-pores, and the lithium manganese phosphate-carbon composite material is high in specific capacity, rate performance and tap density when used as the cathode material of Li-ion batteries; and

(2) the lithium manganese phosphate-carbon composite material is simple in preparation, low in cost, low in the content of carbon and high in the content of active substance.

### BRIEF DESCRIPTION OF THE DRAWINGS

In order to more clearly describe the technical solutions in embodiments of the present application or in the prior art, the accompanying drawings to be used for describing the embodiments or the prior art will be briefly described below. Apparently, the accompanying drawings in the following description are merely some embodiments recorded herein, and a person of ordinary skill in the art may obtain other accompanying drawings according to these accompanying drawings without any creative effort.

FIG. 1 is a scanning electron microscope (SEM) picture of a manganese pyrophosphate (Mn₂P₂O₇) sample prepared in Embodiment 1.

FIG. 2 is an SEM picture of an iron-doped lithium manganese phosphate-carbon composite material having a porous nanostructure prepared in Embodiment 1.

FIG. 3 is an XRD pattern of the iron-doped lithium manganese phosphate-carbon composite material prepared in Embodiment 1.

FIG. 4 is a graph showing charge and discharge curves of first two cycles of a coin cell prepared in Embodiment 1.

FIG. 5 is a graph showing the rate performance of the coin cell prepared in Embodiment 1.

FIG. 6 is an SEM picture of a manganese pyrophosphate-carbon nanotube composite prepared in Embodiment 6 of the present invention.

FIG. 7 is an SEM picture of a lithium manganese phosphate-carbon nanotube composite material prepared in Embodiment 6 of the present invention.

FIG. 8 is an XRD pattern of the lithium manganese phosphate-carbon nanotube composite material prepared in Embodiment 6 of the present invention.

FIG. 9 is a graph showing charge and discharge curves of a coin cell prepared in Embodiment 6 of the present invention.

### DETAILED DESCRIPTION OF THE PRESENT INVENTION

The technical solutions in the embodiments of the present invention will be described below in details with reference to the accompanying drawings in the embodiments of the present invention. Apparently, the embodiments described herein are merely a part of but not all of the embodiments of the present invention. All other embodiments obtained by a person of ordinary skill in the art on the basis of the embodiments in the present invention without any creative effort shall fall into the protection scope of the present invention.

### Embodiment 1

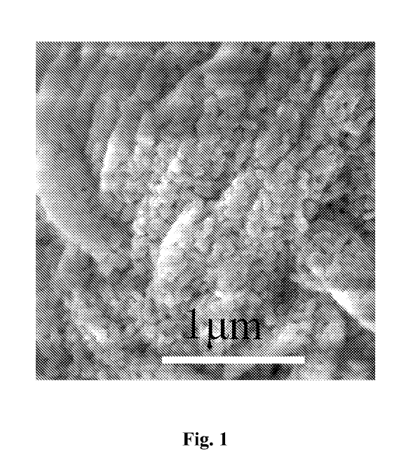

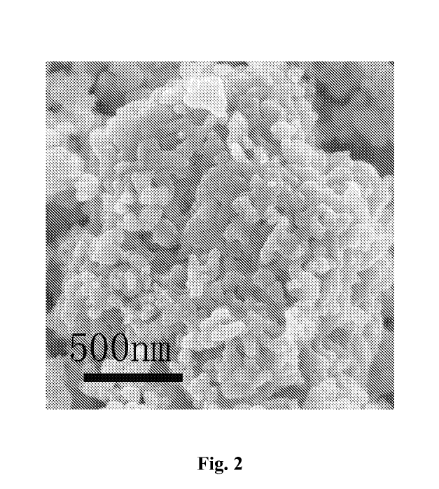

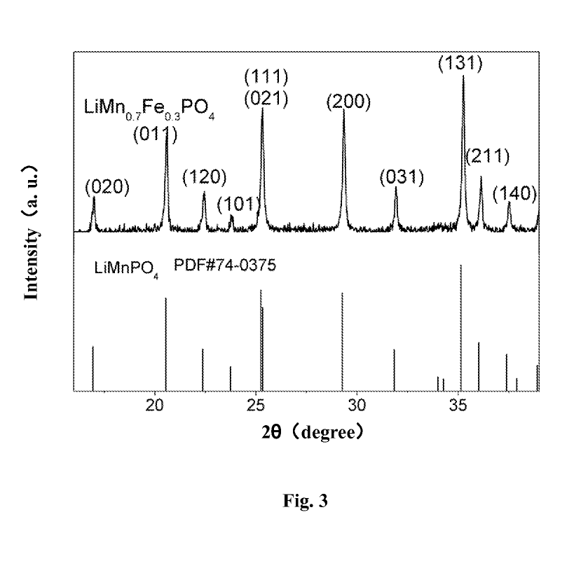

18 mL of 50% Mn(NO₃)₂ aqueous solution, 20 mL of 85% H₃PO₄ aqueous solution, 70 mL of ethanol and 20 mL of water are mixed and stirred for 18 h at 25° C. to obtain a MnPO₄.H₂O material. The MnPO₄.H₂O material is filtered and dried, and then heat-treated for 10 h at 600° C. under the Ar atmosphere to obtain an intermediate Mn₂P₂O₇. A scanning electron microscope (SEM) picture of a sample is as shown in FIG. 1. It can be seen that primary particles have a size of about 50 nm and are agglomerated together to form micro-spheres, with 5-50 nm of nano-pores formed between the particles. 0.8 g of Mn₂P₂O₇ is mixed with 0.44 g of ferrous oxalate (FeC₂O₄), 0.39 g of lithium hydroxide (LiO.H₂O), 0.28 g of ammonium dihydrogen phosphate (NH₄H₂PO₄) and 0.2 g of polyethylene glycol (PEG), and the mixture is added with 15 mL of ethanol, then ball-milled for 6 h and dried at 80° C. to obtain a second reaction precursor. The second reaction precursor is heat-treated for 10 h at 600° C. in the Ar gas flow to obtain a final product, i.e., a lithium iron manganese phosphate-carbon composite material. An SEM picture of the lithium iron manganese phosphate-carbon composite material is as shown in FIG. 2. It can be seen that particles are porous micro-spheres having a size of about 8 μm, with many nano-pores having a size of 3 nm to 50 nm formed between the micro-spheres, and the material thickness between the pores is 20 nm to 70 nm. An X-ray diffraction spectrum (XRD) of the lithium iron manganese phosphate-carbon composite material is as shown in FIG. 3. The spectral line is consistent with the physical phase of the PDF card #74-0375, so it is proved that the material having an olivine phase of LiMnPO₄ has been obtained. The partial shift of a peak is due to the diffusion and doping of iron. Through analysis by an atomic emission spectrometer, a ratio of atoms of Mn to Fe in the sample is 7:3, so the structural formula of the lithium iron manganese phosphate material in the composite material may be expressed as LiMn_{0.7}Fe_{0.3}PO₄. Furthermore, through measurement by an elemental analyzer, the content of carbon by mass percentage in the composite material is about 3%. In addition, a BET specific surface area of the composite material is 18 cm²/g, and a tap density is 1.4 g/cm³.

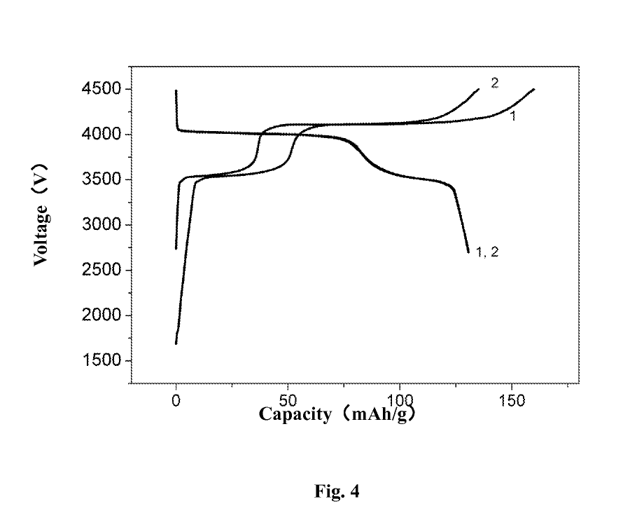

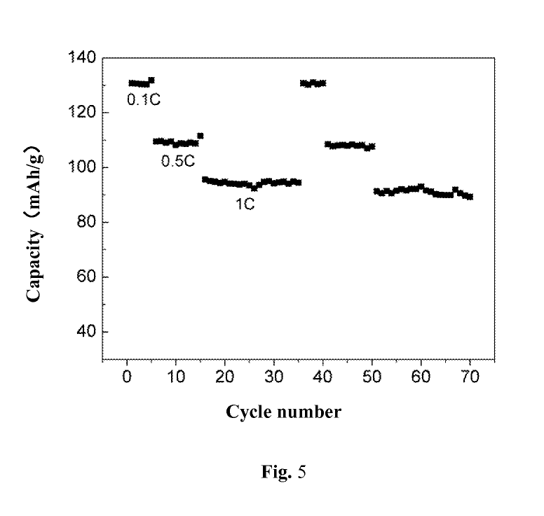

The prepared composite material is mixed with polyvinylidene fluoride and acetylene black at a mass ratio of 85:7.5:7.5 in a NMP solvent, and the mixture is then coated onto aluminum foil and dried in vacuum at 120° C. to obtain an cathode. The cathode and a Li anode together form a 2025-type coin battery. At room temperature, within a voltage window of 2.7 V to 4.5 V, charge and discharge tests are performed at a current density of 0.1 C (1 C=170 mA/g). It is measured that the initial discharge capacity of the cathode material is 132 mAh/g, and the reversible specific capacity is about 130 mAh/g. The curves of the first two cycles of charge and discharge are as shown in FIG. 4. The tested performance of the battery under different charge and discharge currents is as shown in FIG. 5. At 0.5 C, the specific capacity is about 110 mAh/g; and at 1C, the reversible specific capacity is about 95 mAh/g.

### Embodiment 2

18 mL of 50% Mn(NO₃)₂ aqueous solution, 20 mL of 85% H₃PO₄ aqueous solution, 70 mL of ethanol and 20 mL of water are mixed and stirred for 18 h at 25° C. to obtain a MnPO₄.H₂O material. The MnPO₄.H₂O material is filtered and dried, and then heat-treated for 5 h at 600° C. under the air atmosphere to obtain an intermediate Mn₂P₂O₇. 0.8 g of Mn₂P₂O₇ is mixed with 0.44 g of ferrous oxalate (FeC₂O₄), 0.39 g of lithium hydroxide (LiOH.H₂O), 0.28 g of ammonium dihydrogen phosphate (NH₄H₂PO₄) and 0.4 g of PEG, and the mixture is added with 15 mL of ethanol, then ball-milled for 6 h and dried at 80° C. to obtain a second reaction precursor. The second reaction precursor is heat-treated for 10 h at 600° C. in the Ar gas flow to obtain a final product, where the structural formula of the lithium iron manganese phosphate material is LiMn_{0.7}Fe_{0.3}PO₄. Through measurement by an elemental analyzer, the content of carbon in the composite material is about 4 wt %, and the pore volume is 0.1 cm³/g. It is measured by a same method as Embodiment 1 that the specific capacity of the initial discharge capacity of the cathode material is 130 mAh/g.

### Embodiment 3

18 mL of 50% Mn(NO₃)₂ aqueous solution, 20 mL of 85% H₃PO₄ aqueous solution, 70 mL of ethanol and 20 mL of water are mixed and stirred for 18 h at 25° C. to obtain a MnPO₄.H₂O material. The MnPO₄.H₂O material is filtered and dried, and then heat-treated for 5 h at 600° C. under the Ar atmosphere to obtain an intermediate Mn₂P₂O₇. 1.42 g of Mn₂P₂O₇ is mixed with 0.4 g of lithium carbonate (Li₂CO₃) and 0.5 g of glucose, and the mixture is added with 15 mL of ethanol, then ball-milled for 6 h and dried at 80° C. to obtain a second reaction precursor. The second reaction precursor is heat-treated for 10 h at 700° C. in the Ar gas flow to obtain a final product, where the structural formula is LiMnPO₄. Through measurement by an elemental analyzer, the content of carbon in the composite material is about 8 wt %. It is measured by a same method as Embodiment 1 that the initial discharge capacity of the cathode material is 30 mAh/g.

### Embodiment 4

18 mL of 50% Mn(NO₃)₂ aqueous solution, 20 mL of 85% H₃PO₄ aqueous solution, 70 mL of ethanol and 20 mL of water are mixed and stirred for 18 h at 25° C. to obtain a MnPO₄.H₂O material. The MnPO₄.H₂O material is filtered and dried, and then heat-treated for 5 h at 600° C. under the Ar atmosphere to obtain an intermediate Mn₂P₂O₇. 1.14 g of Mn₂P₂O₇ is mixed with 0.36 g of ferrous oxalate (FeC₂O₄), 0.49 g of lithium hydroxide (LiOH.H₂O), 0.23 g of ammonium dihydrogen phosphate (NH₄H₂PO₄) and 0.48 g of glucose, and the mixture is added with 15 mL of ethanol, then ball-milled for 6 h and dried at 80° C. to obtain a second reaction precursor. The second reaction precursor is heat-treated for 10 h at 700° C. in the Ar gas flow to obtain a final product, where the structural formula of the lithium iron manganese phosphate material is LiMn_{0.8}Fe_{0.2}PO₄. Through measurement by an elemental analyzer, the content of carbon in the composite material is about 9 wt %. It is measured by a same method as Embodiment 1 that the initial discharge capacity of the cathode material is 120 mAh/g.

### Embodiment 5

180 mL of 50% Mn(NO₃)₂ aqueous solution, 200 mL of 85% H₃PO₄ aqueous solution, 700 mL of ethanol and 200 mL of water are mixed and stirred for 2 h at 70° C. to obtain a MnPO₄.H₂O material. The MnPO₄.H₂O material is filtered and dried, and then heat-treated for 5 h at 600° C. under the Ar atmosphere to obtain an intermediate Mn₂P₂O₇. 1 g of Mn₂P₂O₇ is mixed with 0.45 g of ferric phosphate (FePO₄.H₂O), 0.49 g of lithium hydroxide (LiOH.H₂O) and 0.4 g of polyethylene glycol, and the mixture is added with 15 mL of methanol, then ball-milled for 6 h and dried at 80° C. to obtain a second reaction precursor. The second reaction precursor is heat-treated for 10 h at 700° C. in the Ar gas flow to obtain a final product, where the structural formula of the lithium iron manganese phosphate material is LiMn_{0.8}Fe_{0.2}PO₄. Through measurement by an elemental analyzer, the content of carbon in the composite material is about 5 wt %. It is measured by a same method as Embodiment 1 that the specific capacity of the first time of discharge of the anode material is 120 mAh/g.

### Embodiment 6

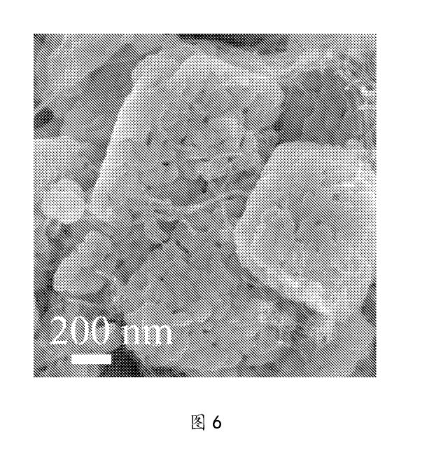

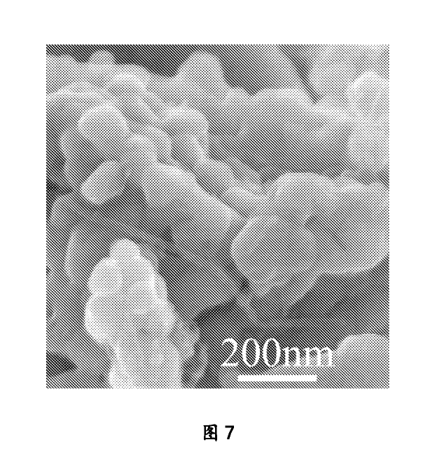

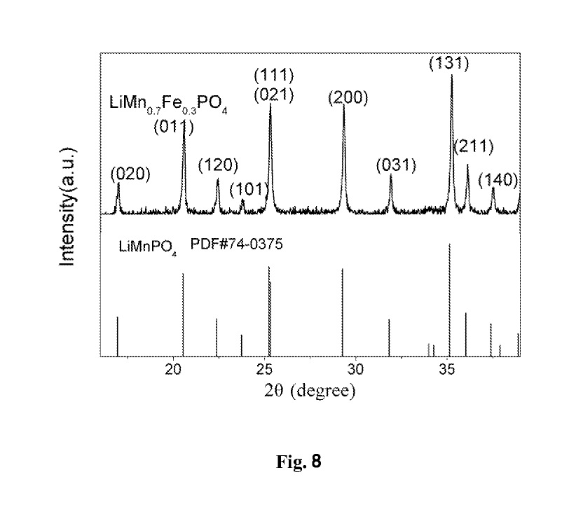

36 mL of 50% manganese nitrate aqueous solution, 40 mL of 85% phosphoric acid aqueous solution, 140 mL of ethanol and 40 mL of water are mixed, and the mixture is added with 0.5 g of multi-walled carbon nanotubes, then ultrasonically dispersed for 30 min and stirred for 24 h at 25° C. to obtain a manganese phosphate-carbon nanotube composite material. The manganese phosphate-carbon nanotube composite material is filtered and dried, and then heat-treated for 10 h at 700° C. under the Ar atmosphere to obtain an intermediate manganese pyrophosphate-carbon nanotube composite material. A scanning electron microscope (SEM) picture of a sample is as shown in FIG. 6. It can be seen that the particle size is of a micro-level, and carbon nanotubes and many pores having a size of 5-50 nm are formed between the particles. 1.08 g of the manganese pyrophosphate-carbon nanotube composite material is mixed with 0.55 g of ferrous oxalate, 0.49 g of lithium hydroxide, 0.35 g of ammonium dihydrogen phosphate and 0.25 g of polyethylene glycol, and the mixture is added with 15 mL of ethanol, then ball-milled for 6 h and dried at 80° C. to obtain a reaction precursor. The reaction precursor is heat-treated for 10 h at 700° C. in the Ar gas flow to obtain a final product, i.e., an iron-doped lithium manganese phosphate-carbon nanotube composite material. An SEM picture of the iron-doped lithium manganese phosphate-carbon nanotube composite material is as shown in FIG. 7. It can be seen that there are porous microparticles containing carbon tubes. An X-ray diffraction spectrum (XRD) of the iron-doped lithium manganese phosphate-carbon nanotube composite material is as shown in FIG. 8. The spectral line is consistent with the phase structure of the PDF card #74-0375, so it is proved that the structure is an olivine phase of LiMnPO₄. The partial shift of a peak is due to the doping of iron. Through analysis by an atomic emission spectrometer, a ratio of atoms of Mn to Fe in the sample is 7:3, so the composition of the composite material may be expressed as LiMn_{0.7}Fe_{0.3}PO₄. A tap density of the material is 1.5 g/cm³. In addition, it can be seen that the carbon nanotubes are in close contact with the surface of lithium manganese phosphate particles, with a distance less than 1 nm and a BET specific surface area of 20 m²/g. Furthermore, the material is of a porous structure containing multiple pores having a diameter less than 50 nm. In addition, the particle surface of the product is further coated with amorphous carbon about 3 nm in thickness, which amorphous carbon is caused by the decomposition of polyethylene glycol.

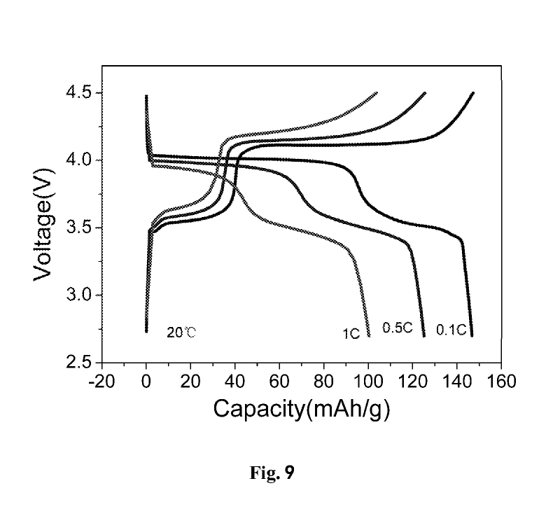

The prepared composite material is mixed with polyvinylidene fluoride and acetylene black at a mass ratio of 85:7.5:7.5 in a NMP solvent, and the mixture is then coated onto aluminum foil and dried in vacuum at 120° C. to obtain a cathode. The cathode and a Li anode together form a 2025 coin cell. At 20° C., within a voltage window of 2.7 V to 4.5 V, charge and discharge tests are performed at a current density of 0.1 C (0.1 C=170 mA/g). It is measured that the specific capacities of the composite material at charge and discharge current densities of 0.1 C, 0.5 C and 1 C are 140 mAh/g, 124 mAh/g and 100 mAh/g, respectively, so it can be seen that the composite material has a good rate capability, as shown in FIG. 9.

### Embodiment 7

18 mL of 50% manganese nitrate aqueous solution, 20 mL of 85% phosphoric acid aqueous solution, 70 mL of ethanol and 20 mL of water are mixed, and the mixture is added with 0.5 g of single-walled carbon nanotubes, then ultrasonically dispersed for 30 min and stirred for 24 h at 25° C. to a manganese phosphate-carbon nanotube composite material. The manganese phosphate-carbon nanotube composite material is filtered and dried, and then heat-treated for 10 h at 700° C. under the Ar atmosphere to obtain an intermediate, i.e., a manganese pyrophosphate-carbon nanotube composite material. 0.96 g of the manganese pyrophosphate-carbon nanotubes is mixed with 0.29 g of ferrous oxalate, 0.39 g of lithium hydroxide, 0.19 g of ammonium dihydrogen phosphate and 0.2 g of polyethylene glycol, and the mixture is added with 15 mL of ethanol, then ball-milled for 12 h and dried at 80° C. to obtain a reaction precursor. The reaction precursor is heat-treated for 10 h at 700° C. in the Ar gas flow to obtain a final product, i.e., an iron-doped lithium manganese phosphate-carbon nanotube composite material. The composition of the composite material may be expressed as LiMn_{0.8}Fe_{0.2}PO₄. It is measured by a same method as Embodiment 1 that the specific discharge capacity of the composite material at 0.1 C is 125 mAh/g.

### Embodiment 8

18 mL of 50% manganese nitrate aqueous solution, 20 mL of 85% phosphoric acid aqueous solution, 70 mL of ethanol and 20 mL of water are mixed, and the mixture is added with 0.5 g of carbon nanofibers, then ultrasonically dispersed for 30 min and stirred for 24 h at 25° C. to a manganese phosphate-carbon nanotube composite material. The manganese phosphate-carbon nanotube composite material is filtered and dried, and then heat-treated for 10 h at 500° C. under the Ar atmosphere to obtain an intermediate manganese pyrophosphate-carbon nanotube composite material. 1.16 g of the manganese pyrophosphate-carbon nanotubes is mixed with 0.32 g of lithium carbonate and 0.2 g of polyethylene glycol, and the mixture is added with 10 mL of ethanol, then ball-milled for 6 h and dried at 80° C. to obtain a reaction precursor. The reaction precursor is heat-treated for 10 h at 700° C. in the Ar gas flow to obtain a final product a lithium manganese phosphate-carbon nanotube composite material. Through elemental analysis, it is indicated that the content of carbon in the composite material is 5%. It is measured by a same method as Embodiment 1 that the specific discharge capacity of the composite material at 0.1 C is 30 mAh/g.

### Embodiment 9

18 mL of 50% manganese nitrate aqueous solution, 20 mL of 85% phosphoric acid aqueous solution, 70 mL of ethanol and 20 mL of water are mixed, and the mixture is added with 0.3 g of multi-walled carbon nanotubes, then ultrasonically dispersed for 30 min and stirred fro 12 h at 25° C. to a manganese phosphate-carbon nanotube composite material. The manganese phosphate-carbon nanotube composite material is filtered and dried, and then heat-treated for 10 h at 700° C. under the Ar atmosphere to obtain an intermediate manganese pyrophosphate-carbon nanotube composite material. 0.96 g of the manganese pyrophosphate-carbon nanotubes is mixed with 0.24 g of magnesium oxalate, 0.39 g of lithium hydroxide, 0.19 g of ammonium dihydrogen phosphate and 0.2 g of polyethylene glycol, and the mixture is added with 15 mL of ethanol, then ball-milled for 12 h and dried at 80° C. to obtain a reaction precursor. The reaction precursor is heat-treated for 10 h at 700° C. in the Ar gas flow to obtain a final product, i.e., an iron-doped lithium manganese phosphate-carbon nanotube composite material. The composition of the composite material may be expressed as LiMn_{0.8}Fe_{0.2}PO₄. It is measured by a same method as Embodiment 1 that the specific discharge capacity of the composite material at 0.1 C is 100 mAh/g.

### Embodiment 10

18 mL of 50% manganese nitrate aqueous solution, 20 mL of 85% phosphoric acid aqueous solution, 70 mL of ethanol and 10 mL of water are mixed, and the mixture is added with 0.2 g of multi-walled carbon nanotubes, then ultrasonically dispersed for 30 min and stirred fro 24 h at 25° C. to a manganese phosphate-carbon nanotube composite material. The manganese phosphate-carbon nanotube composite material is filtered and dried, and then heat-treated for 10 h at 700° C. under the Ar atmosphere to obtain an intermediate manganese pyrophosphate-carbon nanotube composite material. 1.08 g of the manganese pyrophosphate-carbon nanotubes is mixed with 0.55 g of ferrous oxalate, 0.49 g of lithium hydroxide, 0.35 g of ammonium dihydrogen phosphate and 0.25 g of glucose, and the mixture is added with 15 mL of ethanol, then ball-milled for 3 h and dried at 100° C. to obtain a reaction precursor. The reaction precursor is heat-treated for 20 h at 600° C. in the Ar gas flow to obtain an iron-doped lithium manganese phosphate-carbon nanotube composite material. The composition of the composite material may be expressed as LiMn_{0.7}Fe_{0.3}PO₄. It is measured by a same method as Embodiment 1 that the specific discharge capacity of the composite material at 0.1 C is 135 mAh/g.

### Embodiment 11

7 g of manganese sulfate (MnSO₄.H₂O), 5 g of ferrous sulfate (FeSO₄.H₂O), 12 g of ammonium phosphate ((NH₄)₃PO₄.H₂O), 1 g of citric acid and 10 mL of ethanol are ball-milled for 6 h, and then heat-treated for 10 h at 600° C. under the N₂ atmosphere to obtain an intermediate porous iron manganese pyrophosphate ((Mn_{0.7}Fe_{0.3})₂P₂O₇), wherein the content of carbon is about 2 wt %, the particle size is about 1 μm, and there are pores having a size of 5 nm to 30 nm. 1 g of (Mn_{0.7}Fe_{0.3})₂F₂O₇, 0.26 g of lithium carbonate (Li₂CO₃) and 0.25 g of sucrose are ball-milled for 6 h to obtain a reaction precursor. The reaction precursor is heat-treated for 10 h at 800° C. in the N₂ gas flow to obtain a final product, i.e., an iron-doped lithium manganese phosphate-carbon composite material. The composite material mainly contains a compound in a structural formula of LiMn_{0.7}Fe_{0.3}PO₄. After a cathode is manufactured by a same method as Embodiment 1, it is measured that the initial discharge capacity of the cathode material is 130 mAh/g.

### Embodiment 12

30 mL of 70% Mn(NO₃)₂ aqueous solution, 20 mL of 85% H₃PO₄ aqueous solution, 70 mL of ethanol and 50 mL of water are mixed, stirred for 18 h at 75° C., filtered, dried, and heat-treated for 5 h at 400° C. under the Ar atmosphere to obtain an intermediate Mn₂P₂O₇. 1.42 g of Mn₂P₂O₇ is mixed with 0.4 g of lithium carbonate (Li₂CO₃) and 0.4 g of glucose, and the mixture is added with 15 mL of ethanol, then ball-milled for 6 h and dried at 80° C. to obtain a second reaction precursor. The second reaction precursor is heat-treated for 24 h at 500° C. in air to obtain a lithium manganese phosphate-carbon composite material, where the lithium manganese phosphate-carbon composite material mainly contains a compound in a structural formula of LiMnPO₄, and the content of carbon in the composite material is about 1 wt %. After a cathode is manufactured by a same method as Embodiment 1, it is measured that the initial discharge capacity of the cathode material is 30 mAh/g.

### Embodiment 13

7 g of manganese sulfate (MnSO₄.H₂O), 5 g of cobalt sulfate (CoSO₄.7H₂O), 12 g of ammonium phosphate ((NH₄)₃PO₄.H₂O) and 10 mL of ethanol are ball-milled for 6 h, then dried, and heat-treated for 10 h at 800° C. under the N₂ atmosphere to obtain an intermediate porous cobalt manganese pyrophosphate ((Mn_{0.7}Co_{0.3})₂F₂O₇). It is shown by a scanning electron microscope picture of the sample that primary particles have a size of about 60 nm and are agglomerated together to form micro-spheres, with 5-50 nm of nano-pores formed between the particles, a specific surface area of the material is 25 cm²/g, and a pore volume is 0.1 cm³/g. 1 g of (Mn_{0.7}Co_{0.3})₂P₂O₇, 0.26 g of lithium carbonate (Li₂CO₃) and 0.5 g of asphalt are added with 15 mL of ethanol. The mixture is ball-milled for 6 h and dried at 60° C. to obtain a reaction precursor. The reaction precursor is heat-treated for 15 h at 600° C. in the N₂ gas flow to obtain a cobalt-doped lithium manganese phosphate-carbon composite material. The composite material mainly contains a compound in a structural formula of LiMn_{0.7}Co_{0.3}PO₄. After a cathode is manufactured by a same method as Embodiment 1, it is measured that the initial discharge capacity of the cathode material at 0.1 C is 120 mAh/g.

### Embodiment 14

180 mL of 70% Mn(NO₃)₂ aqueous solution, 100 mL of 45% NH₄H₂PO₄ aqueous solution, 700 mL of ethanol and 500 mL of water are mixed, stirred for 2 h at 70° C., filtered, dried, and heat-treated for 5 h at 500° C. under the Ar atmosphere to obtain an intermediate Mn₂P₂O₇. 1 g of Mn₂P₂O₇ is mixed with 0.45 g of ferric phosphate (FePO₄.H₂O), 0.49 g of lithium hydroxide (LiOH.H₂O) and 0.4 g of starch, and the mixture is added with 15 mL of methanol and then ball-milled for 6 h to obtain a second reaction precursor. The second reaction precursor is heat-treated for 10 h at 800° C. in the Ar gas flow to obtain a lithium manganese phosphate-carbon composite material, where the lithium manganese phosphate-carbon composite material mainly contains a compound in a structural formula of LiMn_{0.8}Fe_{0.2}PO₄, the content of carbon in the composite material is about 5 wt %, and the pore volume is 0.15 cm³/g. After a cathode is manufactured by a same method as Embodiment 1, it is measured that the initial discharge capacity of the cathode material at 0.1 C is 120 mAh/g.

### Embodiment 15

10 g of manganese acetate (C₄H₆MnO₄.4₂O), 2.16 g of ferrous oxalate (FeC₂O₄.2H₂O), 1.28 g of magnesium acetate (C₄H₆O₄Mg.4H₂O), 12 g of ammonium phosphate ((NH₄)₃PO₄.H₂O), 5 g of granulated sugar and 10 mL of methylbenzene are ball-milled for 12 h, then dried and heat-treated for 5 h at 700° C. under the nitrogen atmosphere to obtain an intermediate porous iron magnesium manganese pyrophosphate ((Mn_{0.7}Fe_{0.2}Mg_{0.1})₂P₂O₇). The particle size is about 5 μm, and there are multiple pores having a size of 5 nm to 30 nm. 1 g of (Mn_{0.7}Fe_{0.2}Mg_{0.1})₂P₂O₇ is mixed with 0.3 g of lithium hydroxide (LiOH) and 0.5 g of sucrose, and the mixture is added with 15 mL of ethanol and ball-milled for 16 h to obtain a reaction precursor. The reaction precursor is heat-treated for 15 h at 700° C. in the N₂ gas flow to obtain a lithium manganese phosphate-carbon composite material, where the lithium manganese phosphate-carbon composite material mainly contains a compound in a structural formula of LiMn_{0.7}Fe_{0.2}Mg_{0.1}PO₄. A tap density of the material is 1.8 g/cm³, and a specific surface area thereof is 20 m²/g. After a cathode is manufactured by a same method as Embodiment 1, it is measured that the specific capacity of the initial discharge capacity of the cathode material at 0.1 C is 140 mAh/g.

### Embodiment 16

180 mL of 50% Mn(NO₃)₂ aqueous solution, 200 mL of 85% H₃PO₄ aqueous solution, 500 mL of ethanol and 20 mL of water are mixed, stirred for 2 h at 10° C., filtered, dried, and heat-treated for 10 h at 800° C. under the air atmosphere to obtain an intermediate Mn₂P₂O₇. 1 g of Mn₂P₂O₇ is mixed with 0.45 g of ferric phosphate (FePO₄.H₂O), 0.49 g of lithium hydroxide (LiOH.H₂O) and 0.4 g of vitamin C, and the mixture is added with 15 mL of methanol and then ball-milled for 6 h to obtain a second reaction precursor. The second reaction precursor is heat-treated for 30 h at 700° C. in the Ar gas flow to obtain a lithium manganese phosphate-carbon composite material, where the lithium manganese phosphate-carbon composite material mainly contains a compound in a structural formula of LiMn_{0.8}Fe_{0.2}PO₄, and the content of carbon in the composite material is about 5 wt %. After a cathode is manufactured by a same method as Embodiment 1, it is measured that the initial discharge capacity of the cathode material at 0.1 C is 125 mAh/g.

### Embodiment 17

7 g of manganese sulfate (MnSO₄.H₂O), 3.34 g of ferrous sulfate (FeSO₄.H₂O), 1.67 g of cobalt sulfate (CoSO₄.7H₂O), 12 g of ammonium phosphate ((NH₄)₃PO₄.H₂O), 1 g of sucrose and 10 mL of ethanol are ball-milled for 6 h, then dried and heat-treated for 10 h at 600° C. under the N₂ atmosphere to obtain an intermediate cobalt iron manganese pyrophosphate ((Mn_{0.7}Fe_{0.2}Co_{0.1})₂P₂O₇). The content of carbon in the material is about 3%, the particle size is about 10 μm, and there are multiple pores having a size of 5 nm to 30 nm. 1 g of (Mn_{0.7}Fe_{0.2}Co_{0.1})₂P₂O₇ is mixed with 0.26 g of lithium carbonate (Li₂CO₃) and 0.5 g of vinyl acetate, and the mixture is added with 15 mL of acetone, then ball-milled for 12 h and dried at 50° C. to obtain a reaction precursor. The reaction precursor is heat-treated for 10 h at 800° C. in the Ar gas flow to obtain a final product, i.e., a Fe—Co-codoped lithium manganese phosphate-carbon composite material, where the composite material mainly contains a compound in a structural formula of LiMn_{0.7}Fe_{0.2}Co_{0.1}PO₄, and further contains 5% of carbon. After a cathode is manufactured by a same method as Embodiment 1, it is measured that the initial discharge capacity of the cathode material at 0.1 C is 125 mAh/g.

### Embodiment 18

7.24 g of manganese acetate (C₄H₆MnO₄.4H₂O), 6 g of ammonium phosphate ((NH₄)₃PO₄.H₂O), 0.75 g of vinyl acetate and 10 mL of methylbenzene are ball-milled for 12 h, then dried and heat-treated for 5 h at 600° C. under the nitrogen atmosphere to obtain an intermediate Mn₂P₂O₇. The material contains 3% of carbon. 1 g of Mn₂P₂O₇ is mixed with 0.3 g of lithium hydroxide (LiOH), and the mixture is added with 15 mL of ethanol, then ball-milled for 16 h and dried at 80° C. to obtain a reaction precursor. The reaction precursor is heat-treated for 15 h at 700° C. in the N₂ gas flow to obtain a final product, where the final product mainly contains LiMnPO₄ and 2.5% of carbon. After a cathode is manufactured by a same method as Embodiment 1, it is measured that the initial discharge capacity of the cathode material at 0.1 C is 140 mAh/g.

### Embodiment 19

The composite material prepared by the method of Embodiment 1 is mixed with polyvinylidene fluoride and acetylene black at a mass ratio of 8:1:1 in a NMP solvent, and then the mixture is coated onto aluminum foil and dried in vacuum at 120° C. to obtain a cathode of a Li-ion secondary battery. A anode active material using commercially available graphite is mixed with polyvinylidene fluoride and acetylene black at a mass ratio of 8:1:1 in the NMP solvent, and then mixture coated onto copper foil and dried in vacuum at 120° C. to obtain a anode of the Li-ion secondary battery. The anode and cathode flakes, a diaphragm and a lithium hexafluorophosphate electrolyte together form a Li-ion secondary battery. At room temperature, within a voltage window of 2.7 V to 4.5 V, charge and discharge tests are performed at a current density of 0.1 C (0.1 C=170 mA/g). It is measured that the specific capacity of the battery is about 130 mAh/g.

### Embodiment 20

18 mL of 50% manganese nitrate aqueous solution, 20 mL of 85% phosphoric acid aqueous solution, 70 mL of ethanol and 50 mL of water are mixed, and the mixture is added with 1 g of carbon nanofibers, then ultrasonically dispersed for 30 min, stirred for 24 h at 55° C., filtered and heat-treated for 10 h at 800° C. under the Ar atmosphere to obtain an intermediate manganese pyrophosphate-carbon nanofiber composite material. 0.96 g of the manganese pyrophosphate-carbon nanofibers is mixed with 0.29 g of ferrous oxalate, 0.39 g of lithium hydroxide, 0.19 g of ammonium dihydrogen phosphate and 0.2 g of starch, and the mixture is added with 15 mL of ethanol, then ball-milled for 12 h and dried at 80° C. to obtain a reaction precursor. The precursor is heat-treated for 10 h at 650° C. in the Ar gas flow to obtain a final product, i.e., an iron-doped lithium manganese phosphate-carbon nanofiber composite material. It is observed from an electron microscopic picture that the carbon nanofibers are distributed on the surface of and inside the lithium manganese phosphate particles, and a distance between the both is less than 1 nm. The composition of the composite material may be expressed as LiMn_{0.8}Fe_{0.2}PO₄. It is measured by a same method as Embodiment 1 that the specific discharge capacity of the composite material at 0.1 C is 125 mAh/g.

### Embodiment 21

18 mL of 50% manganese nitrate aqueous solution, 20 mL of 85% phosphoric acid aqueous solution, 70 mL of ethanol and 20 mL of water are mixed, and the mixture is added with 0.5 g of carbon nanofibers, then ultrasonically dispersed for 30 min, stirred for 24 h at 25° C., filtered and heat-treated for 10 h at 500° C. under the Ar atmosphere to obtain an intermediate manganese pyrophosphate-carbon nanofiber composite material. 1.16 g of the manganese pyrophosphate-carbon nanofibers is mixed with 0.32 g of lithium carbonate and 0.2 g of acetylene black, and the mixture is added with 10 mL of ethanol, then ball-milled for 6 h and dried at 80° C. to obtain a reaction precursor. The precursor is heat-treated for 10 h at 700° C. in the Ar gas flow to obtain a final product, i.e., a lithium manganese phosphate-carbon nanofiber composite material. The analysis indicates that the content of carbon in the composite material is 5%, the tap density of the material is 1.9 g/cm³, and the BET specific surface area is 19 m²/g. It is measured by a same method as Embodiment 1 that the specific discharge capacity of the composite material at 0.1 C is 30 mAh/g.

### Embodiment 22

18 mL of 50% manganese nitrate aqueous solution, 20 mL of 85% phosphoric acid aqueous solution, 70 mL of ethanol and 20 mL of water are mixed, and the mixture is added with 0.3 g of carbon nanofibers, then ultrasonically dispersed for 30 min, stirred for 12 h at 25° C., filtered and heat-treated for 10 h at 700° C. under the Ar atmosphere to obtain an intermediate manganese pyrophosphate-carbon nanofiber composite material. 0.96 g of the manganese pyrophosphate-carbon nanofibers is mixed with 0.24 g of magnesium oxalate, 0.39 g of lithium hydroxide, 0.19 g of ammonium dihydrogen phosphate and 0.2 g of maltose, and the mixture is added with 15 mL of ethanol and then ball-milled for 12 h to obtain a reaction precursor. The precursor is heat-treated for 10 h at 700° C. in the Ar gas flow to obtain a final product, i.e., an iron-doped lithium manganese phosphate-carbon nanofiber composite material. The composition of the composite material may be expressed as LiMn_{0.8}Mg_{0.2}PO₄. The pore volume in the material is 0.2 cm³/g. It is measured by a same method as Embodiment 1that the specific discharge capacity of the composite material at 0.1 C is 100 mAh/g.

### Embodiment 23

70 mL of 0.5 mol/L manganese nitrate aqueous solution, 30 mL of 0.5 mol/L ferric nitrate aqueous solution, 20 mL of 85% phosphoric acid aqueous solution, 100 mL of ethanol and 50 mL of water are mixed, and the mixture is added with 0.2 g of multi-walled carbon nanotubes, then ultrasonically dispersed for 30 min, stirred for 24 h at 55° C., filtered and heat-treated for 10 h at 500° C. under the Ar atmosphere to obtain an intermediate iron manganese pyrophosphate-carbon nanotube composite material. 1 g of the manganese pyrophosphate-carbon nanotubes is mixed with 0.24 g of lithium carbonate and 0.25 g of cellulose acetate, and the mixture is added with 15 mL of ethanol, then ball-milled for 3 h and dried at 100° C. to obtain a reaction precursor. The precursor is heat-treated for 20 h at 800° C. in the Ar gas flow to obtain an iron-doped lithium manganese phosphate-carbon nanotube composite material. The composition of the composite material may be expressed as LiMn_{0.7}Fe_{0.3}PO₄. It is measured by a same method as Embodiment 1 that the specific discharge capacity of the composite material at 0.1 C is 135 mAh/g.

### Embodiment 24

70 mL of 0.5 mol/L manganese nitrate aqueous solution, 30 mL of 0.5 mol/L ferric nitrate aqueous solution, 20 mL of 85% phosphoric acid aqueous solution, 70 mL of ethanol and 50 mL of water are mixed, stirred for 24 h at 50° C., filtered, dried, and heat-treated for 5 h at 600° C. under the Ar atmosphere to obtain an intermediate iron manganese pyrophosphate. 1.42 g of iron manganese pyrophosphate, 0.4 g of lithium carbonate (Li₂CO₃) and 1 g of starch are grinded for 6 h to obtain a second reaction precursor. The second reaction precursor is heat-treated for 10 h at 600° C. under the acetylene atmosphere to obtain an iron-doped lithium manganese phosphate-carbon nanotube composite material. The composition of the composite material may be expressed as LiMn_{0.7}Fe_{0.3}PO₄, and the content of carbon in the composite material is about 6 wt %. After a cathode flake is manufactured by a same method as Embodiment 1, it is measured that the initial discharge capacity of the cathode material is 100 mAh/g.

### Embodiment 25

7 g of manganese sulfate (MnSO₄.H₂O), 3.34 g of ferrous sulfate (FeSO₄.H₂O), 1.66 g of zinc sulfate (NiSO₄.7H₂O), 12 g of ammonium phosphate ((NH₄)₃PO₄.H₂O), 1 g of polyvinyl alcohol and 10 mL of ethanol are ball-milled for 6 h, then dried and heat-treated for 2 h at 600° C. under the N₂ atmosphere to obtain an intermediate cobalt iron manganese pyrophosphate ((Mn_{0.7}Fe_{0.2}Ni_{0.1})₂P₂O₇). The content of carbon in the material is about 4%. 1 g of (Mn_{0.7}Fe_{0.2}Ni_{0.1})₂P₂O₇ is mixed with 0.26 g of lithium carbonate (Li₂CO₃) and 0.5 g of vinyl acetate, and the mixture is added with 15 mL of water, then stirred for 12 h and dried at 80° C. to obtain a reaction precursor. The reaction precursor is heat-treated for 10 h at 700° C. in the Ar/H₂ gas flow to obtain a final product, i.e., a Fe—Ni co-doped lithium manganese phosphate-carbon composite material, where the composite material mainly contains a compound in a structural formula of LiMn_{0.7}Fe_{0.2}Ni_{0.1}PO₄, and further contains 3% of carbon. After a cathode is manufactured by a same method as Embodiment 1, it is measured that the initial discharge capacity of the cathode material is 130 mAh/g.

It is to be noted that, terms “comprise”, “include” or any other variants in the description are intended to cover non-exclusive inclusion, so that a process, method, object or device including a series of elements not only include these elements, but also further include other elements which are not clearly listed herein, or further include elements inherent to this process, method, object or device. Without more limitations, the element defined by a statement “including a/an . . . ” shall not exclude that a process, method, object or device including this element further has additional same elements. Further, a person of ordinary skill in the art may make other various corresponding variations and deformations according to the technical solutions and technical concept of the present invention, and those variations and deformations shall fall into the protection scope defined by the claims of the present invention.

1. A porous lithium manganese phosphate-carbon composite material, characterized in that multiple nano-pores are distributed in the composite material, the composite material comprises lithium manganese phosphate material and 0.1 wt % to 30 wt % of carbon, and the lithium manganese phosphate material contains compounds in a general formula of LiMnₓM₁₋ₓPO₄, where M comprises any one or more than two of Fe, Co, Ni, Mg, Cu, Zn, Zr, Ti, Al, Cr and Ge, and 0.6≦x≦1, the carbon is at least from amorphous carbon and/or carbon nanotubes and/or carbon nanofibers contained in the composite material, and a distance from the carbon nanotubes or carbon nanofibers to the surface of the lithium manganese phosphate material is less than 1 nm.

2-13. (canceled)

14. A method for preparing the porous lithium manganese phosphate-carbon composite material according to claim 1, comprising the following steps of:
mixing a pyrophosphate material with a lithium source to obtain a reaction precursor, and then calcining the reaction precursor at a constant temperature under a protective atmosphere or an air atmosphere to obtain the porous lithium manganese phosphate-carbon composite material; and
the pyrophosphate material contains compounds in a general formula of (MnₓM₁₋ₓ)₂P₂O₇ and 0 wt % to 30 wt % of carbon, where M is one or more than two of metals.

15. The method for preparing a porous lithium manganese phosphate-carbon composite material according to claim 14, comprising the following steps of: mixing the pyrophosphate material with the lithium source, or adding one or more than two of a doped metal source, a phosphorous source and a carbon source and then mixing, to obtain the reaction precursor, and then calcining the reaction precursor at a constant temperature under a protective atmosphere or an air atmosphere to obtain the porous lithium manganese phosphate-carbon composite material.

16. The method for preparing a porous lithium manganese phosphate-carbon composite material according to claim 14, characterized in that the constant-temperature calcining of the reaction precursor is carried out at a temperature from 100° C. to 2000° C.

17. The method for preparing a porous lithium manganese phosphate-carbon composite material according to claim 14, characterized in that the constant-temperature calcining of the reaction precursor lasts for 0-72 h .

18. The method for preparing a porous lithium manganese phosphate-carbon composite material according to claim 14, comprising the following steps of:
mixing a manganese source with a phosphorous source, or adding one or more than two of a doped metal source and a carbon source and then mixing, to obtain the pyrophosphate material.

19. The method for preparing a porous lithium manganese phosphate-carbon composite material according to claim 18, characterized in that a temperature for heat treatment ranges from 100° C. to 2000° C.

20. The method for preparing a porous lithium manganese phosphate-carbon composite material according to claim 18, characterized in that the heat treatment lasts for 0-72 h .

21. The method for preparing a porous lithium manganese phosphate-carbon composite material according to claim 14, characterized in that the pyrophosphate material is a porous material.

22-23. (canceled)

24. The method for preparing a porous lithium manganese phosphate-carbon composite material according to claim 18, characterized in that a process for preparing the pyrophosphate material comprises the following steps of:
dispersing a manganese source and a phosphorus source, added with carbon nanotubes/nanofibers, or further added with a doped metal source, in a solvent consisting of ethanol and water, and then performing heat treatment under a protective atmosphere or an air atmosphere to form a manganese pyrophosphate-carbon nanotubes/nanofibers composite, i.e., the pyrophosphate material.

25. The method for preparing a porous lithium manganese phosphate-carbon composite material according to claim 18, characterized in that the process for preparing the pyrophosphate material comprises the following steps of: mixing manganese nitrate aqueous solution with phosphoric acid aqueous solution, using a mixture of ethanol and water as a solvent, adding and dispersing carbon nanotubes/nanofibers in the solution, stirring the reaction solution for 0.5-48 h at 10-100° C., filtering and drying, and performing heat treatment at 400-800° C. under an inert atmosphere to obtain the manganese pyrophosphate-carbon nanotubes/nanofibers composite.

26. The method for preparing a porous lithium manganese phosphate-carbon composite material according to claim 18, comprising the following steps of: mixing a manganese salt with phosphoric acid in a solvent mainly consisting of ethanol and water, stirring for above 1 h at 10-100° C., separating and drying the solid, and performing heat treatment to the solid at a temperature of 400-800° C. under an air atmosphere or a protective atmosphere to obtain the pyrophosphate material.

27. The method for preparing a porous lithium manganese phosphate-carbon composite material according to claim 14, characterized in that the pyrophosphate is a metal pyrophosphate or a composite of a metal pyrophosphate and carbon.

28-37. (canceled)

38. An electrode, comprising a substrate and a coating material distributed on the surface of the substrate, characterized in that the coating material contains the porous lithium manganese phosphate-carbon composite material according to claim 1.

39. (canceled)

40. A battery, comprising the porous lithium manganese phosphate-carbon composite material according to claim 1.

41-42. (canceled)

42. A battery, comprising the electrode according to claim 38.
